(19) United States
(12) Patent Application Publication
(10) Pub. No.: US 2004/0045289 A1
(43) Pub. Date: Mar. 11, 2004

(54) Swing control apparatus for swing type hydraulic shovel

(75) Inventors: Muneyoshi Ikeda, Kaga-shi (JP); Norihiro Aoshiba, Komatsu-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KOMATSU LTD., Tokyo (JP)

(21) Appl. No.: 10/609,161

(22) Filed: Jun. 26, 2003

(30) Foreign Application Priority Data
Sep. 6, 2002 (JP) 2002-261076

(51) Int. Cl. F16D 31/02

(52) U.S. Cl. 60/469

(57) ABSTRACT

A swing control apparatus for a swing type hydraulic shovel capable of reducing impact at a stroke end of swing at a low cost. For this purpose, the swing control apparatus includes a swing angle detector for detecting that a swing angle of a working machine, which is swingingly driven by swing drive means, is within a predetermined angle range short of a stroke end, and a controller for outputting a speed reduction command to reduce a swing speed gradually from a position at a predetermined angle short of the stroke end of a swing toward the stroke end, based on a swing angle signal inputted from the swing angle detector.

### TECHNICAL FIELD

The present invention relates to a swing control apparatus for a swing type hydraulic shovel including a working machine of which base end portion is fitted at a front end portion of an upper revolving superstructure to be laterally swingable.

### BACKGROUND ART

There has been a growth in the number of excavating construction works in urban areas in recent years, and in channel excavation along a side of a wall, constructions of curbstones of roads, and the like, the operations are carried out by hydraulic shovels and the like each including a swing boom type working machine capable of doing excavation at a site which is offset laterally from a center of width of a vehicle body.

For example, in a swing boom type working machine as described in Japanese Patent Laid-open No. 63-206535, the entire working machine is swingingly driven by swingingly driving a swing bracket for supporting a base end portion of the working machine by a swing cylinder. By combining the swing of this working machine and turning of the upper revolving superstructure, it is made possible to move a position of a bucket at a tip end of the working machine to be laterally offset. In the case of the swing boom type working machine, it is lighter as compared with an offset boom type working machine including a parallel link mechanism, and therefore it has the advantages of high working speed, favorable stability of the vehicle body, and a large working amount.

However, the aforementioned prior art has the problems as will described hereinafter. Namely, in order to enhance the working ability, the swing drive is normally operated at a maximum speed, and a load falls due to an impact occurring when the working machine reaches a stoke end of the swing, thus worsening operability. Here, operating at the maximum speed means operating with a swing operation pedal being pressed down to the limit, and reaching the stroke end of the swing means reaching the stroke end of the swing cylinder. The impact at the stroke end becomes large in a medium-sized model even of the swing boom type because its working machine is heavy and has the large inertia, though it does not become a problem in a small-sized model. Consequently, the impact and the accompanying vibrations not only worsen riding comfort and operability for the operator, but also the impact causes excessive impact load to act mainly on a swing mechanism, and therefore the impact causes the trouble to the main body of the hydraulic shovel.

It is considered to adopt a swing cylinder including a shock-absorbing mechanism provided with a restrictor at the stroke end, as a method for relieving the impact at the stroke end of the swing. However, the shock-absorbing mechanism has the problems of requiring a large number of man-hours for development to obtain desired shock absorbing performance, and extremely increasing in cost especially because the work for the restrictor is special.

### SUMMARY OF THE INVENTION

The present invention is made in view of the above-described problems, and has its object to provide a swing control apparatus for a swing type hydraulic shovel capable of reducing an impact at a stroke end of swing at a low cost.

In order to attain the above-described object, a swing control apparatus for a swing type hydraulic shovel according to the present invention has: in a swing control apparatus for a swing type hydraulic shovel including a working machine of which base end portion is attached to a front end portion of an upper revolving, superstructure with a swing pin to be laterally swingable, and which is swingingly driven by swing drive means; a constitution including a swing angle detector for detecting that a swing angle of the working machine is within a predetermined angle range short of a stroke end; and a controller for outputting a speed reduction command to reduce a swing speed gradually from a position at a predetermined angle short of the stroke end of a swing toward the stroke end, based on a swing angle signal inputted from the swing angle detector.

According to the above constitution, the swing speed is gradually reduced as the swing approaches the stroke end from the position at the predetermined angle short of the stroke end, and therefore the impact at the stroke end can be reduced to a large extent. Due to this, riding comfort and operability of the operator can be improved, and excessive impact load can be prevented from acting on the main body of the hydraulic shovel.

In the swing control apparatus: the swing drive means may be constituted of a hydraulic actuator; the swing control apparatus may further include an operation valve for controlling a flow rate of pressure oil supplied to the hydraulic actuator correspondingly to an operating amount; and proportional electromagnetic valves capable of controlling pilot pressure for operating the operation valve; and the controller may output the speed reduction command of the swing speed to the proportional electromagnetic valve to control a flow rate of the operation valve. According to this constitution, a special device is not used to constitute the control system, but the speed reduction control is performed by using the proportional electromagnetic valve with general versatility, and therefore the low-cost apparatus is provided.

In the swing control apparatus: the swing control apparatus may further include swing speed detecting means for detecting the swing speed of the working machine; and the controller may output the speed reduction command when the detected swing speed is a predetermined speed or more. According to this constitution, the speed reduction control of the swing speed is performed only when the swing speed is higher than the predetermined speed and the impact at the stroke end becomes large. Consequently, the speed reduction control is not performed when the swing speed is low, and the swing operation corresponding to the operation of the operator is also made possible in the vicinity of the stroke end, thus providing favorable operability.

In the swing control apparatus, the position at which speed reduction of the swing speed is started may be a fixed position irrespective of the swing speed. According to this constitution, the position at which the reduction control of the swing speed is made the fixed position, and therefore the control is simple and conformable to the operator's sense of operation.

In the swing control apparatus: the swing pins may be separated up and down and fitted; and the swing angle detector may be continuously provided at a lower end portion of the upper swing pin out of the separated swing pins. According to this constitution, the swing angle detector is placed at a lower portion of the upper pin out of the two upper and lower pins. Due to this, there is no possibility of breakage by falling objects such as earth and sand and the like from above, and no possibility of breakage by the reinforcing steel bars, branches and the like flipped up from the ground, thus making it unnecessary to provide a cover or the like, and reducing the cost.

### BRIEF DESCRIPTION OF THE DRAWINGS

FIG. 1 is a side view of a swing type hydraulic shovel according to a first embodiment of the present invention;

FIG. 2 is a plan view of the swing type hydraulic shovel according to the first embodiment;

FIG. 3 is an explanatory view of a swing mechanism according to the first embodiment;

FIG. 4 is an explanatory view of an operation of digging a gutter by the swing type hydraulic shovel according to the first embodiment;

FIG. 5 is a side view of a swing angle sensor fitting section according to the first embodiment;

FIG. 6 is an explanatory view of components of the swing angle sensor fitting section in FIG. 5;

FIG. 7 is a block diagram of a swing drive system according to the first embodiment;

FIG. 8 is an output characteristic diagram of a controller according to the first embodiment;

FIG. 9 is an explanatory diagram of an operation according to the first embodiment;

FIG. 10A to FIG. 10C are output characteristic diagrams of a controller of different mode from the first embodiment, FIG. 10A is an example in which a control signal gradually decreases from 100% to m% as swing approaches a stroke end, FIG. 10B is an example in which a speed reduction control area follows a sine curve, and FIG. 10C is an example in which a starting position of the speed reduction control is changed correspondingly to swing speed;

FIG. 11 is a block diagram of a swing drive system according to a second embodiment of the present invention; and

FIG. 12 is an explanatory diagram of an output characteristic of a controller according to the second embodiment.

### BEST MODE FOR CARRYING OUT THE INVENTION

Embodiments will be explained in detail below with reference to the drawings. In this specification, each of the longitudinal, lateral and vertical directions means each of the longitudinal, lateral and vertical directions of a swing type hydraulic shovel to which a swing control apparatus of the present invention is mounted, except when especially noted.

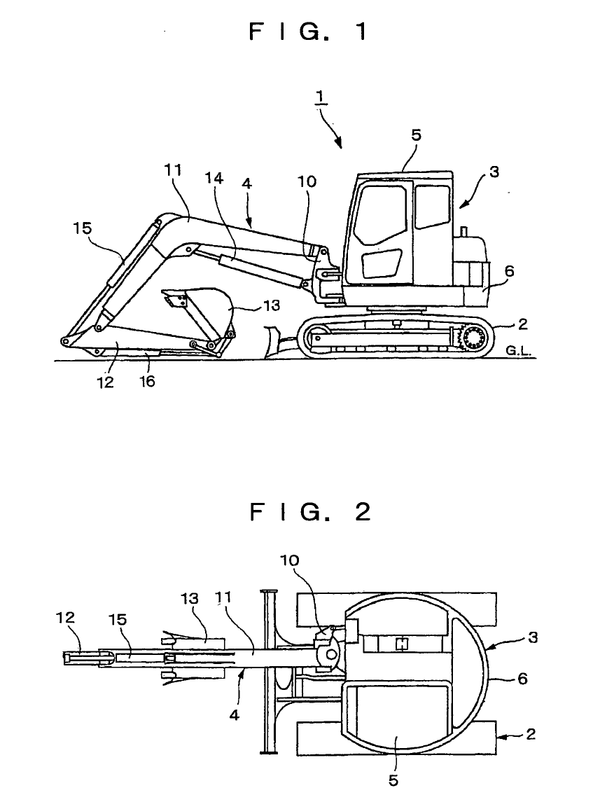

With use of FIG. 1 to FIG. 10C, a first embodiment of the present invention will be explained. As shown in FIG. 1 and FIG. 2, a hydraulic shovel 1 includes a base carrier 2 including crawler belt type traveling units on its left and right, an upper revolving superstructure 3 which is rotatably mounted on an upper part of the base carrier 2, and a working machine 4 mounted to a front end portion of the upper revolving superstructure 3. A driver's cab is loaded on a left side of a front part of the upper revolving superstructure 3, and a counterweight 6 is loaded on a rear end portion of the upper revolving superstructure 3. A rear part of the upper revolving superstructure 3 of the hydraulic shovel 1 that is a small rear-revolving type is in a cylindrical shape of substantially a semicircle to be turnable in a predetermined maximum radius.

The working machine 4 has a boom 11 of which base end portion is attached to a swing bracket 10 to be able to hoist and lower, and an arm 12 of which base end portion is rotatably mounted to a tip end portion of the boom 11. A bucket 13 as a working tool has its base end portion rotatably attached to a tip end portion of the arm 12. The working machine 4 further has a boom cylinder 14 attached between the swing bracket 10 and the boom 11, an arm cylinder 15 attached between the boom 11 and the arm 12, and a bucket cylinder 16 attached between the arm 12 and the bucket 13. The working machine 4 is driven by extending and contracting drive of these hydraulic cylinders 14, 15 and 16.

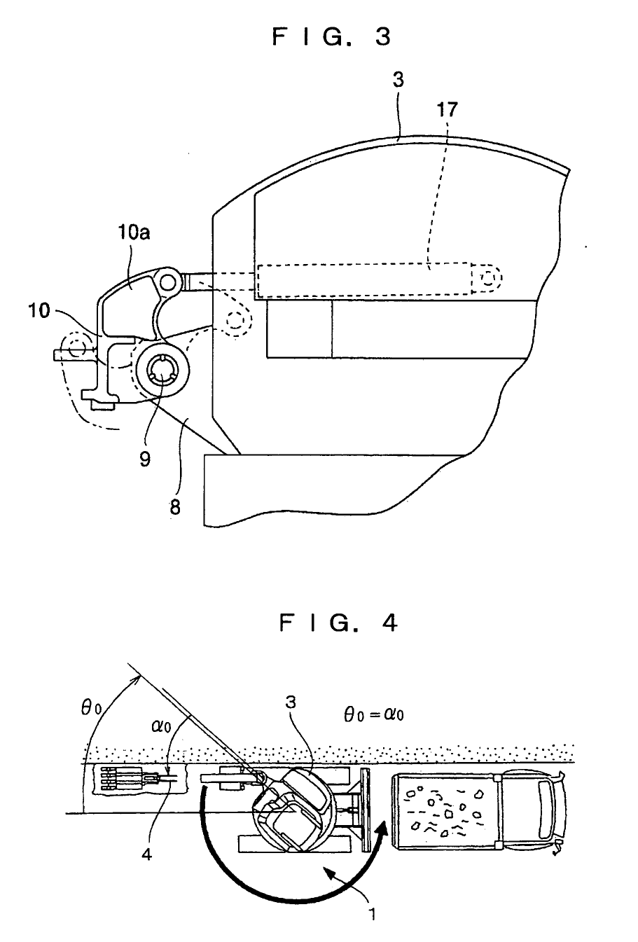

The swing bracket 10 for supporting the boom 11, which becomes a base end portion of the working machine 4 is attached to a support bracket 8 provided at the front end portion of the upper revolving superstructure 3 by a pin 9 in a vertical direction to be swingable in a lateral direction. The working machine 4 is swingingly driven with the swing bracket 10 by extending and contracting drive of a swing cylinder 17 that is attached between a tip end portion of a lever 10a, which is provided to protrude rightward (the upward in FIG. 3) from the swing bracket 10, and the upper revolving superstructure 3.

As described above, the hydraulic shovel 1 is a swing type hydraulic shovel including the swing boom type working machine 4. Therefore, for example, as shown in FIG. 4, the working machine 4 is swingingly driven at a swing angle α0 in a leftward direction, and the upper revolving superstructure 3 can be rotationally driven so that a rotational angle θ0 in a rightward direction opposite to the swing direction becomes substantially the angle α0. Consequently, the tip end position of the working machine 4 can be moved to be offset rightward from a center of width of the vehicle body, thus making it possible to facilitate channel excavation along a side of a wall at a right side of the vehicle body.

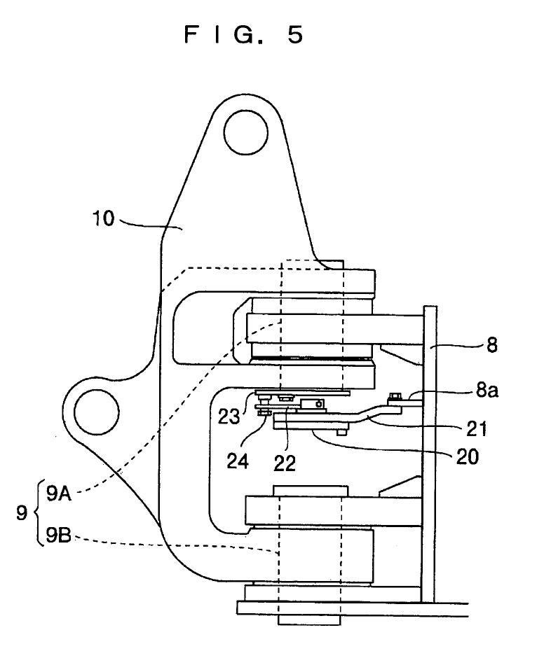

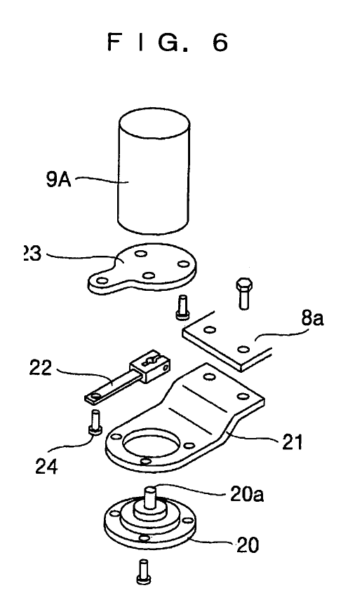

Next, based on FIG. 5, a swing angle sensor 20 for detecting a swing angle α in a lateral direction of the working machine 4 will be explained. The pin 9 for attaching the swing bracket 10 to the support bracket 8 is constituted of two upper and lower pins 9A and 9B, and swingably connects the swing bracket 10 and the support bracket 8 at two upper and lower spots on the same axis. The swing angle sensor 20 is placed under the upper pin 9A rotating integrally with the swing bracket 10. Namely, explaining also with FIG. 6, the swing angle sensor 20 constituted mainly of, for example, a potentiometer is attached to a sensor fixing part 8a in a plate shape provided to protrude forward from the support bracket 8 via a mounting bracket 21 so that a rotating shaft 20a is on the same axis as the axis of the pin 9A. A lever 22 is attached to the rotating shaft 20a, and a tip end portion of the lever 22 is engaged with a post 24 vertically provided at an end portion of a plate 23 attached at a lower end of the pin 9A, thereby detecting the rotational (swing of the swing bracket 10) angle α of the pin 9A.

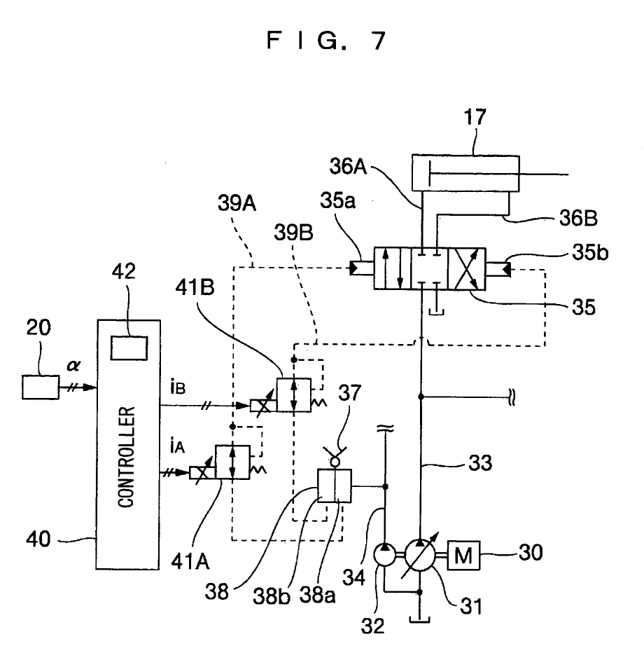

As shown in FIG. 7, discharge sides of a variable displacement hydraulic pump 31 rotated with an engine 30 as a driving source and a hydraulic pump 32 for generating pilot pressure are connected to conduit lines 33 and 34, respectively. The conduit line 33 is connected to a swing operation valve 35 and other operation valves (for example, a boom operation valve, a turning operation valve and the like, though not shown), and supplies pressure oil discharged from the hydraulic pump 31 to these operation valves. The swing operation valve 35 is connected to the swing cylinder 17 via conduit lines 36A and 36B at a secondary side.

The conduit line 34 is connected to a pilot valve 38 operated by a swing operation pedal 37 and other pilot valves (a pilot valve for boom operation, a pilot valve for turning operation and the like, though not shown), and supplies pilot pressure discharged from the hydraulic pump 32 to these pilot valves. The pilot valve 38 includes decompression sections 38a and 38b. The decompression section 38a is connected to an operation section 35a of the swing operation valve 35 via a pilot conduit line 39A, and controls the supplied pilot pressure to switch the swing operation valve 35 to extend the swing cylinder 17 (left swing). The decompression section 38b is connected to an operation section 35b of the swing operation valve 35 via a pilot conduit line 39B, and controls the supplied pilot pressure to switch the swing operation valve 35 to contract the swing cylinder (right swing).

Proportional electromagnetic valves 41A and 41B which are driven according to command signals iA and iB from a controller 40 are interposed in the pilot conduit line 39A and the pilot conduit line 39B, respectively. The swing angle sensor 20 is connected to the controller 40. The controller arithmetically operates the command signals iA and iB to the proportional electromagnetic valves 41A and 41B and outputs them, based on the swing angle signal α from the swing angle sensor 20.

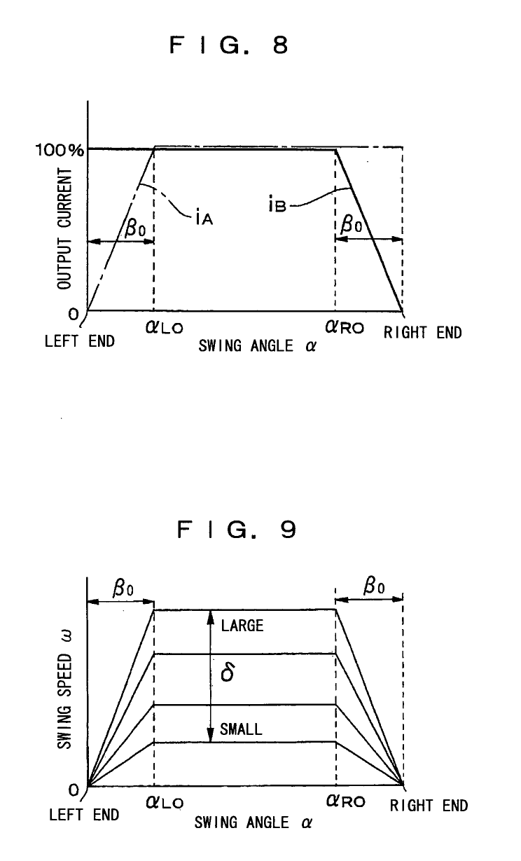

As shown in FIG. 8, when the position at a predetermined angle β0 short of a left stroke end is assumed to be a position αL0, the command signal iA (indicated by the alternate long and short dashed line) to the proportional electromagnetic valve 41A capable of controlling the pilot pressure for the left swing is made an output signal of 100% in a range from the position αL0 to the right stroke end (namely, the opening amount of the proportional electromagnetic valve 41A is full). The command signal iA has the characteristic that it gradually decreases from 100% to 0% according to the swing angle α as the swing is approaching the left stroke end from the position αL0. On the other hand, when the position at the predetermined angle β0 short of a right stroke end is assumed to be a position αR0, the command signal iB (indicated by the solid line) to the proportional electromagnetic valve 41B capable of controlling the pilot pressure for the right swing is made an output signal of 100% in a range from the position αR0 to the left stroke end (namely, the opening amount of the proportional electromagnetic valve 41B is full). The command signal iB has the characteristic that it gradually decreases from 100% to 0% according to the swing angle α as the swing is approaching the left stroke end from the position αR0. For the predetermined angle β0, a sufficient angle range is set to reduce the swing speed to be slow enough to make the impact at the stroke end trivial even when the swing speed is the maximum.

An operation according to the above-described constitution will be explained with use of FIG. 9. In an intermediate part of the swing stroke, the opening amounts of the proportional electromagnetic valves 41A and 41B are full, and therefore the swing operation valve 35 is operated according to the pilot pressure corresponding to an operation amount δ of the swing operation pedal 37. Consequently, the swing cylinder 17 is supplied with the pressure oil corresponding to the operation amount δ via the conduit line 36A or the conduit line 36B, and is driven to extend and contract. As a result, the working machine 4 is driven to swing at a swing speed ω based on the pedal operation amount δ in the intermediate part of the swing stroke.

On the other hand, in the vicinity of the stroke end at the left side, for example, even if the operation amount δ of the swing operation pedal 37 is fixed, the pilot pressure of the conduit line 39A is reduced by the proportional electromagnetic valve 41A of the conduit line 39A and decompression advances as the swing is approaching the left stroke end. For this reason, the operation amount of the swing control valve 35 becomes small and thereby the extending speed of the swing cylinder 17 reduces with the reduction in pressure oil supplied via the conduit line 36A, and stops at the left stroke end. The situation is the same as in the vicinity of the stroke end at the right side.

Due to this, the swing speed W is gradually reduced toward the stroke end in the range of the predetermined angle β0 back from the stroke end of the swing and the swing stops at the stroke end, thus making it possible to prevent the impact at the stroke end. As the positions at which the reduction control of the swing speed ω is started are made the fixed positions αL0 and αR0 each at the angle β0 short of the stroke end, the control is simple and easily conforms to the sense of operation of the operator. Instead of using a special device to construct the control system, the control system is constituted by using the proportional electromagnetic valves 41A and 41B and the potentiometer (swing angle sensor 20) with general versatility, thus providing the low-cost apparatus. Since the swing angle sensor 20 is placed at a lower part of the upper pin 9A of the two upper and lower pins 9A and 9B, there is no fear of breakage by falling objects such as earth and sand from above, and there is no fear of breakage by reinforcing steel bars, branches and the like flipped up from the ground, thus making it unnecessary to provide a cover or the like and reducing the cost.

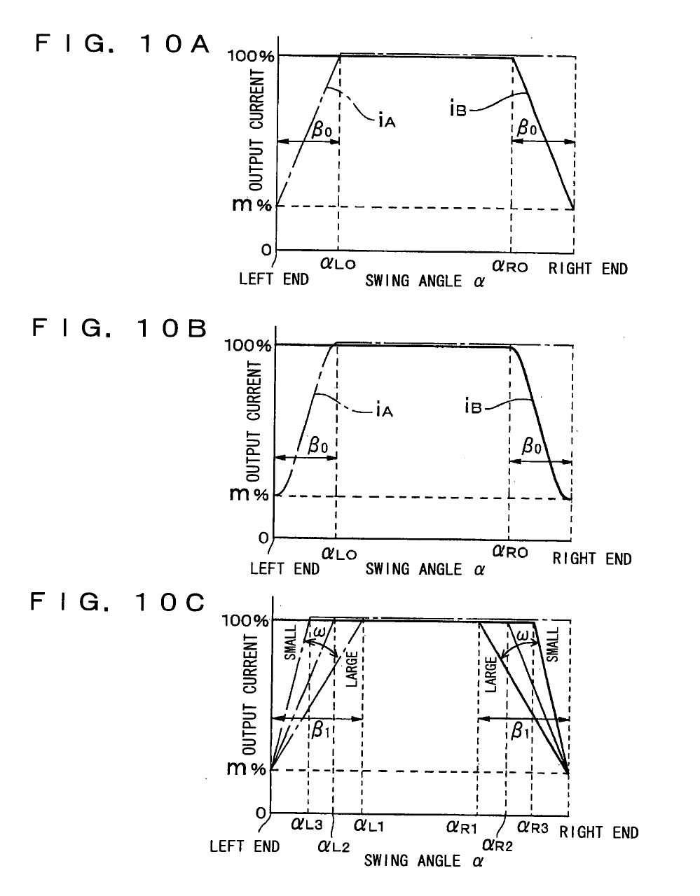

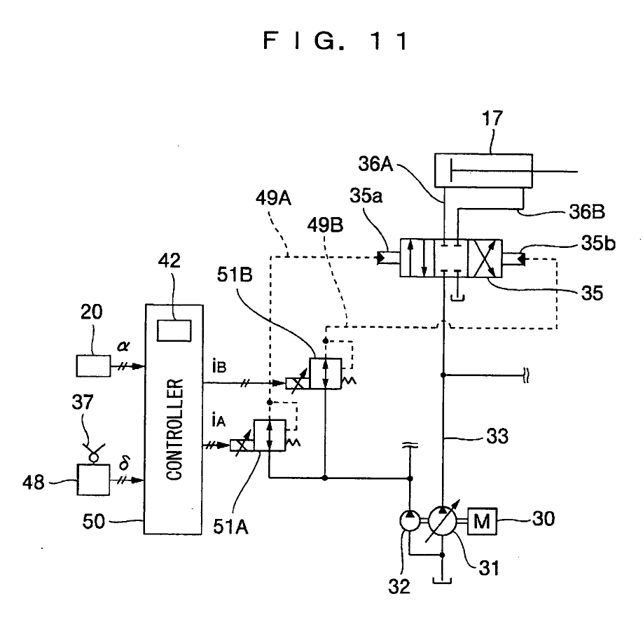

In the first embodiment, the explanation is made with the example in which the command signals iA and iB to the proportional electromagnetic valves 41A and 41B are gradually decreasing from 100% to 0% as the swing is approaching the stroke end from the positions αL0 and αR0 at the predetermined angle β0 short of the stroke end. However, even if the command signals are set at 0% output at the stroke end, it sometimes happens that the swing stops before the stroke end due to the influence by an error or the like, and therefore it is desirable to provide the characteristic that the command signals are gradually decreasing from 100% to m% as shown in FIG. 10A. Here, m% corresponds to an output of, for example, about 5% which provides the swing speed ω slow enough to make the impact at the stroke end trivial. According to this, the swing speed co at the time of the swing reaching the stroke end can be controlled to be a creeping speed to reduce the impact to be caused.

The speed reduction control area may not have the linear characteristic, but it may have the output characteristic following the sine curve, for example, as shown in FIG. 10B, or it may have the output characteristic in the form of a polygonal line closely analogous to the sine curve. According to this, the impact at the time of change in speed at the time of starting the speed reduction or the like becomes extremely small, and thus the riding comfort of the operator can be improved.

The explanation is made with the example in which the speed reduction control of the swing speed W is started at the fixed positions αL0 and αR0, but the starting positions αL and αR of the speed reduction control may be changed according to the swing speed U as shown in FIG. 10C. Namely, the starting positions αL and αR of the speed reduction control of the swing speed ω are made positions αL1 and αR1 each at an angle β1 short of the stroke end when the swing speed ω is maximum due to the swing operation pedal 37 in the maximum depressed state. The speed reduction starting positions αL and αR are set at the positions αL2, αL3, . . . , αR2, αR3, . . . near the stroke end in accordance with the swing speed ω, which is calculated by swing speed detecting means 42 based on the swing angle signal a from the swing angle sensor 20. According to this, the wide area in which the speed reduction control is not performed according to the swing speed ω, namely, the wide swing area in which the speed follows the operation of the operator can be secured.

For swing angle detection to determine the speed reduction control area, an encoder, or a limit switch may be used without being limited to the potentiometer. In the case of a limit switch, a signal may be outputted according to the time so that the speed reduction acceleration becomes the same as that by the speed reduction command when the working machine is operated at the maximum speed.

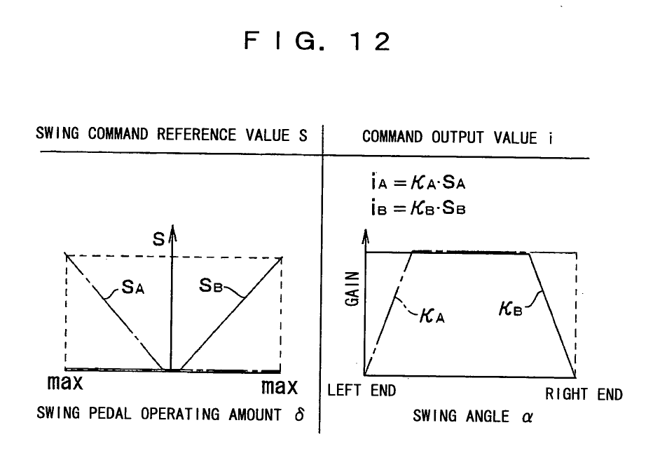

Next, with use of FIGS. 11 and 12, a second embodiment of the present invention will be explained. In the first embodiment, the explanation is made with the example of the hydraulic control type driving system using the pilot valve 38 which is operated by the swing operation pedal 37, but in the second embodiment, the present invention is applied to an electrical control type driving system using a detector for electrically detecting an operation amount of the swing operation pedal 37. It should be noted that the same components as in the first embodiment are given the same numerals and symbols, and the explanation of them will be omitted.

As shown in FIG. 11, the pedal operating amount signal δ from a pedal operating amount sensor 48 for detecting an operating amount of the swing operation pedal 37, and the swing angle signal a from the swing angle sensor 20 are inputted into a controller 50. The controller 50 is constituted to arithmetically operate the command signals iA and iB to proportional electromagnetic valves 51A and 51B provided at pilot conduit lines 49A and 49B for connecting the operating sections 35a and 35b of the swing, operation valve 35 and the hydraulic pump 32 respectively, based on the inputted signals δ and α, and output them.

As shown in FIG. 12, swing command reference values SA and SB which are substantially proportional to the swing pedal operation amount δ are multiplied by gain characteristics κA and κB having the same characteristics as the output characteristics explained in FIG. 8, or FIG. 10A to FIG. 10C, which are outputted as the command signals iA and iB. According to this, the same operational effect as in the case of the hydraulic control type driving system of the first embodiment can be also obtained in the electrical control type driving system of the second embodiment. Further, the swing control apparatus capable of speed reduction control can be constituted by adding the swing angle sensor 20 to the standard electrical control type driving system, and therefore the extremely low-cost control apparatus can be obtained.

It should be noted that the present invention is not limited to the above-described embodiments, and various modifications and corrections may be added to it within the scope of the present invention. In the above-described embodiments, the explanation is made with the example in which the speed reduction control of the swing speed ω60 is performed in the vicinity of the stroke end of the swing irrespective of the speed of the swing speed ω. However, when the swing speed ω is the predetermined speed ω0 or less, the command signals iA and iB may be the output signals of 100% in the entire range without carrying out the arithmetic operation based on the characteristic in that the output of the signal is gradually decreasing, which is explained in FIG. 8, FIG. 10A to FIG. 10C, and the like. The swing speed detecting means 42 for detecting the swing speed ω used in this determination may calculate the swing speed ω based on the swing angle signal α from the swing angle sensor 20, or may be additionally provided with a tacho-generator or the like to perform detection.

According to the above, the above-described speed reduction control is not performed when the swing speed ω is the predetermined speed ω0 or less even in the vicinity of the stroke end, and the swing cylinder 17 drives to extend and contract at a speed corresponding to the operating amount δ. By setting the value, which makes the impact at the stroke end trivial, as the predetermined speed ω0, the reduction control of the swing speed ω is performed only when the swing speed ω is higher than the predetermined speed ω0 and the impact at the stroke end becomes large. As a result, the speed reduction control is not performed when the swing speed ω is low, and the swing operation according to the operation of the operator becomes also possible in the vicinity of the stroke end.

Instead of determining effectiveness or ineffectiveness of the speed reduction control according to the predetermined speed ω0, the control apparatus may be constituted so that the speed reduction control is not performed when the pedal operating amount signal δ of the second embodiment is a predetermined operating amount δ0 or less. By additionally providing a detector for detecting the operating amount of the swing operation pedal 37 in FIG. 7, the same control is also made possible in the first embodiment. When pressure sensors (or pressure switches) are provided in the pilot conduit lines 39A and 39B in FIG. 7, and the control apparatus is constituted not to perform the speed reduction control when the pressure is predetermined pressure or more, the same operational effect can be also obtained.

Instead of providing the hydraulic pump 32 for generating the pilot pressure, a pressure reducing valve may be provided in the conduit line 33 to obtain the pilot pressure. Adjustors including switches and volumes may be connected to the controllers 40 and 50 to constitute the control apparatus capable of adjusting the angle β0, values of the m% and the like of the output characteristic according to the preference of the operator. Further, the swing drive means is not limited to the hydraulic cylinder 17, but it may be a hydraulic motor, an electric motor, an electric cylinder and the like. In the case of the electric motor and the electric cylinder, speed control can be made via a servo amplifier with the controller.

As explained thus far, according to the present invention, the swing speed of the working machine is gradually decreased as the swing is approaching the stroke end in the vicinity of the stroke end of the swing, and therefore the impact at the stroke end can be reduced. Only when the swing speed is high, and the impact at the stroke end becomes large, the speed reduction control of the swing speed is performed, and therefore when the swing speed is low, the swing operation corresponding to the operation of the operator also becomes possible in the vicinity of the stroke end.

What is claimed is:

1. A swing control apparatus for a swing type hydraulic shovel including a working machine of which base end portion is attached to a front end portion of an upper revolving superstructure with a swing pin to be laterally swingable, and which is swingingly driven by swing drive means, comprising:
a swing angle detector for detecting that a swing angle of said working machine is within a predetermined angle range short of a stroke end; and
a controller for outputting a speed reduction command to reduce a swing speed gradually from a position at a predetermined angle short of the stroke end of a swing toward the stroke end, based on a swing angle signal inputted from said swing angle detector.

2. The swing control apparatus for the swing type hydraulic shovel according to claim 1,
wherein said swing pins are separated up and down and fitted; and
wherein said swing angle detector is continuously provided at a lower end portion of the upper swing pin out of said separated swing pins.

3. The swing control apparatus for the swing type hydraulic shovel according to claim 1,
wherein said swing drive means is constituted of a hydraulic actuator;
said swing control apparatus further comprising:
an operation valve for controlling a flow rate of pressure oil supplied to said hydraulic actuator correspondingly to an operating amount, and
proportional electromagnetic valves capable of controlling pilot pressure for operating said operation valve; and
wherein said controller outputs the speed reduction command of the swing speed to said proportional electromagnetic valve to control a flow rate of said operation valve.

4. The swing control apparatus for the swing type hydraulic shovel according to claim 3,
wherein said swing pins are separated up and down and fitted; and
wherein said swing angle detector is continuously provided at a lower end portion of the upper swing pin out of said separated swing pins.

5. The swing control apparatus for the swing type hydraulic shovel according to claim 1, further comprising:
swing speed detecting means for detecting the swing speed of said working machine,
wherein said controller outputs said speed reduction command when the detected swing speed is a predetermined speed or more.

6. The swing control apparatus for the swing type hydraulic shovel according to claim 5,
wherein said swing pins are separated up and down and fitted; and
wherein said swing angle detector is continuously provided at a lower end portion of the upper swing pin out of said separated swing pins.

7. The swing control apparatus for the swing type hydraulic shovel according to claim 1, wherein said position at which speed reduction of the swing speed is started is a fixed position irrespective of the swing speed.

8. The swing control apparatus for the swing type hydraulic shovel according to claim 7,
wherein said swing pins are separated up and down and fitted, and
wherein said swing angle detector is continuously provided at a lower end of the upper swing pin out of said separated swing pins.
